(19) United States
(12) Patent Application Publication
(10) Pub. No.: US 2024/0183749 A1
(43) Pub. Date: Jun. 6, 2024

(54) TRANSMISSION BELT ARRANGEMENT

(71) Applicants: AKTIEBOLAGET SKF, GOTEBORG (SE); SKF MAGNETIC MECHATRONICS, SAINT-MARCEL (FR)

(72) Inventors: Lakdar SADI-HADDAD, Nogent sur Marne (FR); Josue SAURY, Saint-Marcel (FR); Lloyd BROWN, Singapore (SG); David BEGGS, Rizal (PH)

(21) Appl. No.: 18/514,329

(22) Filed: Nov. 20, 2023

(30) Foreign Application Priority Data
Dec. 1, 2022 (DE) 102022212955.5

(51) Int. Cl. G01M 13/023; F16G 1/00; G01M 13/028

(52) U.S. Cl. CPC G01M 13/023; F16G 1/00; G01M 13/028

(57) ABSTRACT

A transmission belt arrangement includes a transmission belt, at least one sensor for providing a parameter indicative of a vibration signature of the transmission belt arrangement, and processing circuitry for determining a state of the transmission belt based on the parameter and/or based on the vibration signature indicated by the parameter.

### CROSS-REFERENCE

This application claims priority to German patent application no. 10 2022 212 955.5 filed on Dec. 1, 2022, the contents of which are fully incorporated herein by reference.

### TECHNOLOGICAL FIELD

The present disclosure is directed to a transmission belt arrangement and to a method for determining a state of a transmission belt and to a method for monitoring a condition of a transmission belt.

### BACKGROUND

Transmission belts are well-known components to transmit power between two rotatable shafts in a machine. Tension that is too low can allow the belt to slip, which can damage or destroy the belt due to overheating. Tension that is too high can damage the bearings that support the rotatable shafts that support belt by overloading the shafts. To ensure trouble-free operation and to benefit from all the properties of a transmission belt, special attention is paid to the initial installation. Once the belt is in operation, the belts are normally no longer monitored although they deteriorate over time. For instance, based on environmental conditions and other factors such as how the machinery is operated, the belt can deteriorate faster than expected, and this will decrease efficiency and potentially cause irreversible damage to the system. A way of monitoring the condition of a belt after initial installation is to provide the transmission belt with sensors for sensing and collecting data regarding a condition of the transmission belt and batteries to power the sensors. The data can then be read and analyzed. However, adding batteries and sensors complicates the manufacturing and add weight to the belt. Further, the manufacturing may be delayed based on availability of a particular sensor. Also, sensors tend to break, and batteries run out of power, thereby hindering the collection of data regarding the condition of the belt.

### SUMMARY OF THE INVENTION

In view of the above, a first aspect of the disclosure is to provide an improved transmission belt arrangement. A further aspect is to provide a method for monitoring a condition of a transmission belt by determining a state of the transmission belt of a transmission belt arrangement. A yet further aspect is to provide an improved method for monitoring a condition of a transmission belt.

According to a first aspect of the disclosure, a transmission belt arrangement includes a transmission belt, a sensor for providing a parameter indicative of a vibration signature of the transmission belt arrangement, and processing circuitry for determining a state of the at least one transmission belt. The state of the transmission belt is determined on the basis of a vibration signature of the transmission belt arrangement.

An improved transmission belt arrangement is provided, for which a parameter indicative of a vibration signature of the transmission belt arrangement is provided by the sensor, and a state of the transmission belt is determined by the processing circuitry. In particular, it has been realized that by using the vibration signature to determine the state of the transmission belt, a sensor for sensing a state of a transmission belt does not need to be integrated into the transmission belt. Thereby, fewer components are needed and a more robust and reliable transmission belt is achieved in a cost-effective manner. Furthermore, a simplified and cost-effective production of the belt is achieved.

The present disclosure also provides a better performing transmission belt because fewer components need to be integrated onto or into the belt, potentially weakening the structure of the belt. Furthermore, because less weight is added to a spot of the belt to provide for the sensing and transmitting functionality, the belt is less sensitive to becoming unbalanced, thereby providing for a better functioning transmission belt. Consequently, the machinery in which the transmission belt is applied is naturally also better operated. This is especially the case for applications with high rotating speed.

By “a state” of the transmission belt as used herein is meant any physical parameter possible to measure by interpreting the distance between the at least one sensor and the at least one transmission belt. These physical parameters may be, but is not limited to, for instance force, temperature, strain, acceleration, elongation, pressure and/or humidity. These parameters are all relevant to either the condition of the belt or the environment in which the belt is operating. The parameters may also be used to monitor how the machinery in which the belt is installed is operated. These are all things that ultimately affects the condition and service life of the transmission belt.

The belt may at least partly be made from rubber. It may also be made from any other suitable material, or any combinations of suitable materials for providing the proper characteristics of the belt in question. The combination of materials may be for instance include metal wires to provide strength and/or parts made from fabric or textiles. The belt may comprise any other material or combination of suitable materials.

The sensor may be attached to a static frame of the transmission belt arrangement. Optionally, the sensor may be attached to a pulley in the transmission belt arrangement. The pully may be a drive pulley connected to a motor or engine or a driven pulley. Still optionally, the sensor may be attached to a motor or engine driving the drive pulley in the transmission belt arrangement. As described hereinafter, the sensor may be more than one sensor. In such an example, the multiple sensors may be located in different places; for example, the sensors may be attached to one or more of the static frame, a pully and/or the motor or engine as described above.

The processing circuitry may be wirelessly connected to the at least one sensor. Alternatively, the procession circuitry may be connected to the at least one sensor by a physical connection. The processing circuitry receives the parameter indicative of a distance between the at least one sensor and the at least one transmission belt from the at least one sensor before determining a state of the at least one transmission belt.

By “a vibration signature”, is meant a vibration produced by and/or otherwise associated with the transmission belt arrangement that is measured by a sensor. The vibration of the transmission belt arrangement may be measured over a predetermined time period. The vibration signature may then be determined or generated based on the measurements. Optionally, vibration measurements from more than on sensor may be combined to determine or generate the vibration signature of the transmission belt arrangement. A vibration signature may also be referred to as a vibration pattern. As the state of a transmission belt changes, e.g., by an elongation of the transmission belt, the vibration of the transmission belt arrangement changes as well. This enables a determination of a state of a transmission belt, such as an elongation of the transmission belt.

A parameter indicative of a vibration signature may mean that the parameter comprises data enabling a vibration signature to be determined. Alternatively, the parameter indicative of a vibration signature may indicate the actual vibration signature. In such an example, the actual vibration signature is determined by the sensor providing the parameter.

Optionally, the sensor is an accelerometer or a piezoelectric sensor.

Optionally, the sensor measures the parameter. Still optionally, the processing circuitry obtains the parameter from a signal output by the sensor.

Optionally, the state may be a state of elongation of the at least one transmission belt. As the belt is elongated, the processing circuitry determine the elongation, such as the state of the transmission belt, based on the vibration signature of the transmission arrangement. E.g., the vibration signature changes with the elongation of the transmission belt. As such, the processing circuitry will determine a state of the transmission belt corresponding to the elongation of the transmission belt. The state of elongation may be determined as an elongation relative an initial length of a transmission belt. Thus, in some examples, the processing circuitry may determine a state of a transmission belt based on a comparison of a vibration signature of the transmission belt arrangement and a vibration signature of a reference transmission belt arrangement. The reference vibration signature is a vibration signature when the transmission belt is new. Different transmission belts may have different reference vibration signatures, e.g., depending to the type of transmission belt.

Optionally, the sensor provides the parameter indicative of a vibration signature of the transmission belt arrangement to the processing circuitry. The processing circuitry may determine the vibration signature based on the parameter. The sensor may provide the parameter to the processing circuitry using a wireless and/or physical connection between the sensor and the processing circuitry as discussed above.

Optionally, the state of the transmission belt is determined based on a comparison of the vibration signature of the transmission belt arrangement and a reference vibration signature of the transmission belt arrangement. This may enable a changes of the vibration signature to be detected. Changes to a vibration signature may indicate a changed state of the transmission belt. Thus, by determining the state of the transmission belt based on a comparison of the vibration signature and a reference vibration signature, it may be possible to detect a deteriorated state of the transmission belt, an over tension of the transmission belt and/or an under tension of the transmission belt.

Optionally, the sensor is more than one sensor. The processing circuitry determines the vibration signature of the transmission belt arrangement based on parameters indicative of the vibration signature provided from the more than one sensor. In some examples, the processing circuitry determines the vibration signatures of the transmission belt based on all the parameters provided by the more than one sensor. In other examples, the processing circuitry determines a vibration signature of the transmission belt arrangement, where each vibration signature is associated with a parameter. In such an example, the processing circuitry determines a state of a transmission belt on the basis of the determined vibration signatures.

The present disclosure also relates to a method for determining a state of a transmission belt in a transmission belt arrangement. The transmission belt arrangement includes a transmission belt, a sensor for measuring or providing a parameter indicative of a vibration signature of the transmission belt arrangement and processing circuitry for determining a state of the transmission belt. The method includes determining a state of the transmission belt on the basis of a vibration signature of the transmission belt arrangement.

The present disclosure also relates to a method for monitoring a condition of a transmission belt by determining a state of the transmission belt in a transmission belt arrangement according to embodiments herein. The method includes comparing the determined state with a predetermined criterion. The predetermined criterion may be a threshold. For example, when the state is a state of elongation, the threshold may be a threshold related to elongation.

Optionally, the method for monitoring a condition of a transmission belt may include issuing a notification if the determined state fulfils the predetermined criterion. Fulfilling the predetermined criterion may mean that a signal is above the threshold.

### BRIEF DESCRIPTION OF THE DRAWINGS

The present disclosure will hereinafter be further explained by means of non-limiting examples with reference to the appended schematic figures wherein:

FIG. 1 is a schematic view, partly in section, of a transmission belt arrangement according to an exemplary embodiment of the present disclosure.

FIG. 2A is a schematic view, partly in section, of a transmission belt arrangement according to an exemplary embodiment of the present disclosure.

FIG. 2B is a schematic view, partly in section, of a transmission belt arrangement according to an exemplary embodiment of the present disclosure.

FIG. 3A is a schematic view of a transmission belt arrangement according to an exemplary embodiment of the present disclosure.

FIG. 3B is a schematic view, partly in section, of a transmission belt arrangement according to an exemplary embodiment of the present disclosure.

FIG. 4A is a schematic view of a transmission belt arrangement according to an exemplary embodiment of the present disclosure.

FIG. 4B is a schematic view of a transmission belt arrangement according to an exemplary embodiment of the present disclosure.

FIG. 5 is a flowchart of a method according to an exemplary embodiment of the present disclosure.

FIG. 6 is a flowchart of a method according to an exemplary embodiment of the present disclosure.

FIG. 7 is a flowchart of a method according to an exemplary embodiment of the present disclosure.

### DETAILED DESCRIPTION OF EMBODIMENTS

It should be noted that the drawings have not necessarily been drawn to scale and that the dimensions of certain features may have been exaggerated for the sake of clarity. Like reference signs in the drawings refer to the same or similar element, unless expressed otherwise.

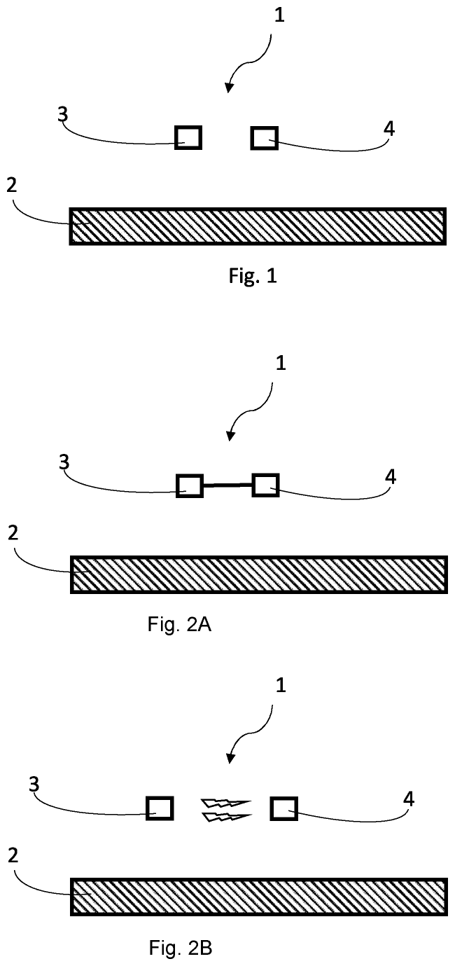

FIG. 1 is a schematic view of a transmission belt arrangement 1 according to an exemplary embodiment of the present disclosure. The transmission belt arrangement 1 comprises a transmission belt 2 and a sensor 3. It should be noted that only a portion of the transmission belt is shown in FIG. 1. The portion of the transmission belt 2 depicted is the portion under traction (tension). The at least one sensor 3 is arranged to provide a parameter indicative of a vibration signature of the transmission belt arrangement 1. The transmission belt arrangement 1 further comprises processing circuitry 4. The processing circuitry 4 is arranged to determine a state of the transmission belt 2. The state of the transmission belt 2 is determined based on a vibration signature of the transmission belt arrangement 1.

FIG. 2A is a schematic view of a transmission belt arrangement 1 according to an exemplary embodiment of the present disclosure. Here, the processing circuitry 4 is connected to the sensor 3 in a physical manner to transfer the parameter or any other data. For example, a wire from the processing circuitry 4 may be connected to the sensor 3. Such connection to provide a parameter indicative of a vibration signature of the transmission belt arrangement 1 may physically be done in any other suitable way.

FIG. 2B is a schematic view of a transmission belt arrangement 1 according to an exemplary embodiment of the present disclosure. Here, the processing circuitry 4 is connected to the sensor 3 in a wireless manner to transfer the parameter or any other data. For example, a wireless communication interface in the processing circuitry 4 may communicate wirelessly with a wireless interface of the sensor 3. The wireless interface may be a wireless interface for communicating via e.g., Bluetooth or Wi-Fi. Such connection to provide a parameter indicative of a vibration signature of the transmission belt arrangement 1 may wirelessly be done in any other suitable way.

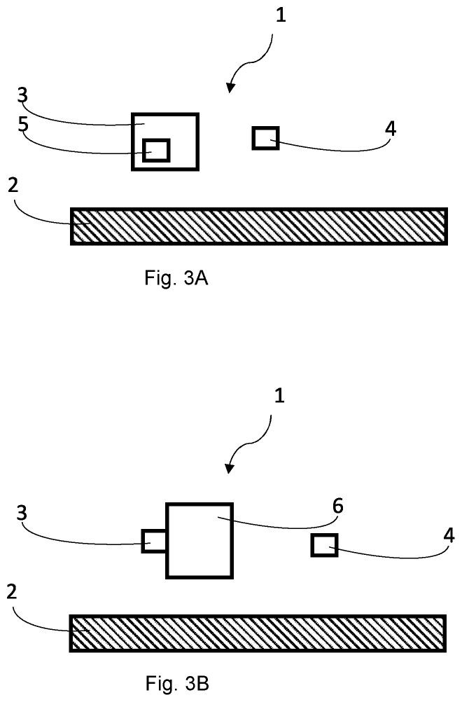

FIG. 3A is a schematic view of a transmission belt arrangement 1 according to an exemplary embodiment of the present disclosure. Here, the sensor 3 of the transmission belt arrangement 1 of any of FIGS. 2A or B can be seen complemented with an integrated circuit 5 that may include memory. The integrated circuit 5 may be used for storing parameter data in case the parameter would not be able to be provided to the processing circuitry 4 at some point. Then the parameter, and any related data, may be stored and provided later upon a successful connection between the processing circuitry 4 and the sensor 3.

FIG. 3B is a schematic view of a transmission belt arrangement 1 according to an exemplary embodiment of the present disclosure. Here, the sensor 3 of the transmission belt arrangement of any of FIGS. 2A or B can be seen to be connected with a separate integrated circuit 6. The integrated circuit 6 may be used for storing parameter data in case the parameter would not be able to be provided to the processing circuitry at some point. Then the parameter, and any related data, may be stored and provided later upon a successful connection between the processing circuitry 4 and the integrated circuit 6. In some examples, the transmission belt arrangement 1 of FIGS. 3A and B may be combined, such that the sensor 3 is complemented with an integrated circuit 5 and the sensor 3 is connected to the integrated circuit 6.

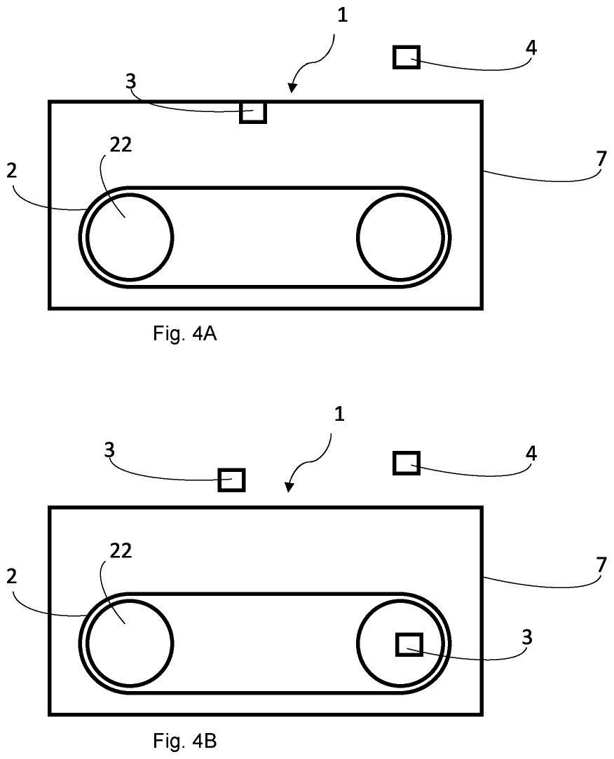

FIG. 4A is a schematic view of a transmission belt arrangement 1 according to an exemplary embodiment of the present disclosure. Here the transmission belt arrangement 1 any of FIGS. 1-4 is complemented with a guard 7 enclosing the transmission belt 2. Further, the transmission belt arrangement 1 can be seen comprising the transmission belt 2 over two pulleys 22. One of the pulleys may be a drive pulley connected to an engine or motor, and the other pulley may be a driven pulley connected to a vehicle or machinery. The sensor 3 is attached to the guard to monitor the at least one transmission belt 2 in order to e.g., measure the parameter indicative of a vibration signature of the transmission belt arrangement 1.

FIG. 4B is a schematic view of a transmission belt arrangement 1 according to an exemplary embodiment of the present disclosure. Here the transmission belt arrangement 1 of FIGS. 1-4 is complemented with a guard enclosing the at least one transmission belt 2. The sensor 3 is attached to a pulley 22 of the transmission belt arrangement 1 in order to measure the parameter indicative of the vibration signature of the transmission belt arrangement 1. They pulley 22 may be a drive pulley or a driven pulley. In other examples of embodiments of the present disclosure (not shown), the sensor 3 may be attached to a static frame of the transmission belt arrangement 1 and/or a motor of the transmission belt arrangement 1. When attached to the static frame of the transmission belt arrangement, the sensor 3 may be positioned such that it is attached close to a pulley 22 of the transmission belt arrangement 1. As mentioned above, the transmission belt arrangement 1 may comprise more than one sensor 3. In such an example, the sensors may be attached according to any one or more of the examples presented above in FIG. 4A and B.

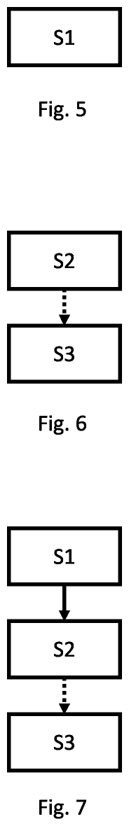

FIG. 5 is a flowchart of a method according to an exemplary embodiment of the present disclosure. The method is a method includes a step S1 for determining a state of a transmission belt 2 in a transmission belt arrangement 1. The transmission belt arrangement 1 (see e.g., FIG. 1) comprises a transmission belt 2, a sensor 3 for providing or measuring a parameter indicative of a vibration signature of the transmission belt arrangement 1, and processing circuitry 4 for determining a state of the transmission belt 2. The method comprises determining a state of the transmission belt 2 on the basis of a vibration signature of the transmission belt arrangement 1. For instance, a degree of elongation of the transmission belt 2 may be determined.

FIG. 6 is a flowchart of a method according to an exemplary embodiment of the present disclosure. The method is a method for monitoring a condition of a transmission belt 2 by determining at a step S1 a state of the transmission belt 2 as described in FIG. 6. The method comprises comparing at a step S2 the determined state with a predetermined criterion. By comparing a determined state with a predetermined criterion, the state of a transmission belt 2 can classified as to whether further actions need to be taken.

FIG. 7 is a flowchart of a method according to an exemplary embodiment of the present disclosure. The flowchart of the method can be seen comprising a further optional step S3 of issuing a notification if the determined state fulfils the predetermined criterion. This way, the situation can be analysed in order to take suitable actions to maintain an efficient operation of the transmission belt arrangement, such as planning for servicing or replacing the transmission belt 2.

A combination of the methods for determining a state transmission belt 2 as shown in

FIG. 6 and for monitoring a condition of a transmission belt 2 as shown in FIG. 7 can also be performed.

It is to be understood that the present disclosure is not limited to the embodiments described above and illustrated in the drawings; rather, the skilled person will recognize that many changes and modifications may be made within the scope of the appended claims.

It is to be understood that the present disclosure is not limited to the embodiments described above and illustrated in the drawings; rather, the skilled person will recognize that many changes and modifications may be made within the scope of the appended claims.

What is claimed is:

1. A transmission belt arrangement comprising:
a transmission belt,
at least one sensor configured to measure a parameter indicative of a vibration signature of the transmission belt arrangement, and
processing circuitry for determining a state of the transmission belt based on the parameter and/or based on the vibration signature.

2. The transmission belt arrangement according to claim 1, wherein the at least one sensor is an accelerometer.

3. The transmission belt arrangement according to claim 1, wherein the at least one sensor is configured to measure the parameter.

4. The transmission belt arrangement according to claim 1, wherein the state is a degree of elongation of the transmission belt.

5. The transmission belt arrangement according to claim 1,
wherein the at least one sensor is configured to provide the parameter to the processing circuitry, and
wherein the processing circuitry is configured to determine the vibration signature of the transmission belt arrangement based on the parameter.

6. The transmission belt arrangement according to claim 1,
wherein the processing circuitry is configured to compare the vibration signature indicated by the parameter to a reference vibration signature.

7. The transmission belt arrangement according to claim 1,
wherein the at least one sensor comprises a plurality of sensors, and
wherein the processing circuitry is configured to determine the vibration signature of the transmission belt arrangement based on parameters provided by the plurality of sensors.

8. A method for determining a state of a transmission belt of a transmission belt arrangement comprising:
sensing a parameter indicative of a vibration signature of the transmission belt arrangement and outputting a signal indicative of the parameter,
determining a state of the transmission belt based on the parameter and/or the vibration signal.

9. The method according to claim 8, further comprising comparing the state with a predetermined criterion.

10. The method according to claim 9, further comprising issuing a notification if the determined state meets the predetermined criterion.
